(19) United States
(12) Patent Application Publication
(10) Pub. No.: US 2012/0109026 A1
(43) Pub. Date: May 3, 2012

(54) THERMAL TRANSFER DEVICE

(76) Inventor: Kevin McWilliams, Warwickshire (GB)

(21) Appl. No.: 13/260,791

(22) PCT Filed: Mar. 30, 2010
(86) PCT No.: PCT/GB2010/050542

§ 371 Date: Jan. 18, 2012

(30) Foreign Application Priority Data
Mar. 30, 2009 (GB) 09054065
Mar. 30, 2009 (GB) 09054073

(51) Int. Cl. A61H 1/00

(52) U.S. Cl. 601/17

(57) ABSTRACT

A massage tool heating or cooling device (1) for heating or cooling one or more massage tools (10). The device includes a base assembly (2) incorporating a heating or cooling element (5), a conduction plate (4) and a conductive layer (11) that is deformable to cooperate with a surface of a tool (10) to be heated in order to provide intimate thermal contact therewith. The conduction plate (4) is preferably provided with a plurality of recesses (8) and each of these recesses (8) includes a conductive layer (11). In use, heat applied or removed by the heating or cooling element (5) is transferred to or from the massage tool (10) via the conductive layer (11) and the conduction plate (4).

This invention relates generally to thermal transfer devices and more specifically, although not exclusively, to massage tool heating and/or cooling devices for heating and/or cooling stones for use as massage tools.

It is well known to use heated stones as massage tools in a therapeutic massage treatment to improve blood circulation, assist in lymph drainage, reduce muscle tension and relieve pain in both muscles and joints. It is also well known to use heated and cooled stones in a therapeutic massage treatment. These stones, in conjunction with the use of the therapist's hands, are known to create a state of deep relaxation both physically and mentally. Also, by using the different sides and faces of the stone, particularly in deep tissue massage, they are useful in reducing the stress on the hands of the therapist over prolonged period of treatment.

Typically for hot therapy treatments, stones with a relatively high specific heat capacity and a relatively low thermal conductivity are used that absorb and retain the heat, releasing it slowly during the treatment.

One example of such a stone is Basalt, an igneous rock formed by volcanic and sedimentary action. Typically Basalt has a density of 2,500 Kg/m³, a specific heat capacity of 0.9 KJ/Kg/k and a thermal conductivity of 1.5 w/mk. It is also relatively hard with a hardness of 7 on the Mohs' Scale. Most varieties contain olivine and iron-magnesium silicate; those containing notable quantities of this mineral are known as olivine basalt. This olivine basalt is a fine-grained stone that is very dense and forms fine crystalline masses. The stones begin to form when gabbroic magma erupts as lava flows or intrudes at shallow depths to form dikes and sills. Vesicular structure is prominent at the top of the lava flow. Gasses trapped in the cooling lava form vesicles; after solidification, secondary minerals like quartz and zeolites fill these cavities.

Hot and cold stone massage is the application of heated stones, usually made from basalt, and cooled stones, usually made from marble, combined with manual massage. This provides the patient with a deeply relaxing, therapeutic experience. For instance, one method is to first apply heat from the hot stones to a specific area and then apply the cold stones immediately afterwards on the same area.

The combination of hot and cold stones provides therapeutic balance. Warm stones soften fascia faster and more deeply than traditional massage therapies while cold stones disperse congestion, alleviate swelling and interrupt muscle spasms. Heated stones increase blood circulation, lymph and digestive fluids and have sedating effects. Cold stones stimulate the autonomic nervous system, increase metabolism and invigorate the body.

The stones for use in hot therapy treatments are typically heated by full immersion in an electrically heated thermostatically controlled water tank. This method is both low cost and simple and through measurement and control of the water temperature gives a reliable method for ensuring that the stones are raised to the correct temperature before use.

The heating can be achieved relatively quickly as the immersion of the stones in the water allows a good heat transfer from the water to the stones as the water completely surrounds and contacts the stones surface regardless of the irregular shape of each natural stone.

By retaining a number of stones in the water tank, the stones can be maintained at the correct temperature during extended therapy treatments until removed by the therapist for use in the treatment.

However, heating the stones in this way requires both preparation of the water tank some time before use and regular cleaning and maintenance to ensure the appropriate cleanliness of the water, tank and stones. In addition, the use of water can have other practical disadvantages. Immediately on removal from the tank the stones are wet and may require drying before use. In removing the stones from the tank the therapist's hands also become wet. The water on either the stones or the therapists hands if not removed can also interfere with the effectiveness of any oils or solutions used in the treatment.

The user can handle stones at relatively high temperatures as the poor thermal conductivity of the stone material reduces the transfer of heat from the stone to the skin. However, the water may in some cases need to be so hot to raise the stones to the correct operating temperature for use, that the user is forced to wear a glove when removing stones from the tank to avoid pain or even scalding.

Usually stones of different sizes are used during therapeutic massage treatments for different parts of the body, which is also a disadvantage to the user to have to search within the tank for the correct stone.

Similarly, cooling of the cold stones is generally achieved by placing them in a refrigeration unit or immersing them into an ice bath. However, the former arrangement requires considerable time to cool stones from ambient temperature and the latter presents difficulties in accurately controlling their temperature.

It is therefore a general object of the invention to provide an improved heating and/or cooling device for heating and/or cooling massage tools and/or which at least mitigates the aforementioned issues with prior art heating and/or cooling devices.

It is a more specific, non-exclusive object of the invention to provide a heating or cooling device capable of heating and/or cooling massage tools which are irregularly shaped. It is a further non-exclusive object of the invention to provide a heating and/or cooling device which heats and/or cools massage tools in a manner that is dry, clean and easy to use. It is yet a further non-exclusive object of the invention to provide a heating and/or cooling device which facilitates the selection of one of two or more massage tools heated and/or cooled simultaneously by the device.

It is a further more specific non-exclusive object of the invention to provide an apparatus which can simultaneously heat one or more hot massage tools or stones and cool one or more cold massage tools or stones to be used in a hot and cold tool or stone therapeutic massage treatment.

One aspect of the invention provides a massage tool heating and/or cooling device for heating and/or cooling one or more massage tools, the device comprising a heating and/or cooling element and a conductive layer which is deformable to cooperate with a surface of a tool to be heated or cooled to provide intimate thermal contact therewith, whereby heat applied or removed, in use, by the heating and/or cooling element is transferred to the massage tool through the conductive layer.

The use of a conductive layer is a convenient means of providing the intimate thermal contact with the tool.

The conductive layer is preferably arranged to facilitate or improve, in use, conduction between the heating and/or cooling element and the massage tool or tools. The conductive layer may comprise a flexible, malleable and/or porous material which may also be soaked or filled or retain a quantity of heat conductive fluid such as water. Additionally or alternatively, the conductive layer may be provided by a flexible pouch, e.g. which may be filled with a conductive fluid such as water.

Alternatively, the device may comprise one or more thermal conduction portions between the heating and/or cooling element and the conductive layer, wherein the or at least one of the thermal conduction portions or parts or formations or conductive layers may comprise a heat conductive fluid such as water, e.g. which is contained in or retained within the formation.

In some embodiments, the device comprises a conduction plate, which may be flat, e.g. with the conductive layer, which may also be flat, placed or located thereon. The conductive layer is preferably configured to deform and/or to conform at least partially to the shape of a massage tool placed, in use, thereon.

The conductive layer may be configured to cover, in use, less than 60%, e.g. less than 50% or even less than 40%, of the outer surface of a massage tool.

The device may further comprise a thermal conduction formation shaped to approximate a surface of a tool to be heated and/or cooled, wherein the conductive layer may be located on or in the thermal conduction formation.

A second aspect of the invention provides a heating and/cooling device, for example a massage tool heating device, for heating and/or cooling one or more massage tools, the device comprising a heating and/or cooling element and a thermal conduction formation shaped to approximate a surface of a tool to be heated and/or cooled for providing intimate thermal contact therewith, whereby heat applied or removed, in use, by the heating and/or cooling element is transferred to or from the massage tool through the thermal conduction formation.

By specifically adapting the shape of the formation heating and/or cooling element to cooperate with a surface of the massage tool, there is no need to use water to heat and/or cool the massage tool.

The thermal conduction formation may comprise a silicon material loaded with conductive particles.

The heating and/or cooling element may be in thermal contact with the thermal conduction formation, e.g. to apply or remove heat thereto or therefrom through conduction. The heating and/or cooling element may comprise a heating element, e.g. a resistive heating element. Additionally or alternatively, the or a further heating element may be arranged to apply radiant heat to the thermal conduction formation.

The heating and/or cooling device is preferably configured to heat and/or cool the one or more massage tools to a predetermined temperature. The heating and/or cooling device may comprise a controller for controlling the heat applied or removed by the heating and/or cooling element. Additionally or alternatively, the heating and/or cooling device may comprise a temperature sensor or thermostat for measuring and/or controlling the temperature of one or more elements of the device, e.g. the heating and/or cooling element and/or the thermal conduction formation.

The thermal conduction formation is preferably incorporated within a thermal conduction part, for example a thermal conduction plate. The device may further comprise an insulation part, for example an insulation plate or lid, e.g. arranged to cooperate with an outer surface of a massage tool such as by being flexible or deformable to approximate the shape of the outer surface of the massage tool. The insulation part may include an insulation formation or recess or cavity, which may be shaped to cooperate with an outer surface of a massage tool. Preferably, the insulation formation or recess or cavity is on a surface of the insulation part which faces the thermal conduction part in use. In one class of embodiments, the insulation formation cooperates, in use, with the thermal conduction formation to substantially surround the massage tool.

The thermal conduction part and/or insulation part may comprise two or more conduction or insulation formations, e.g. three or more or a plurality of conduction or insulation formations. Each of the formations may be shaped to cooperate with a surface of a respective massage tool to be heated and/or cooled, for example to provide intimate thermal contact therewith, e.g. whereby heat applied or removed, in use, by the heating and/or cooling element is transferred to the massage tool through the thermal conduction formation and/or heat is prevented from being discharged from the massage tool by the insulation formation.

Additionally or alternatively, the device may include a second thermal conduction part in place of the insulation part. The device may comprise a second heating and/or cooling element, e.g. wherein heat applied or removed, in use, by the second heating and/or cooling element is transferred to the massage tool through a second or further thermal conduction formation of the second thermal conduction part.

The heating and/or cooling device may comprise two or more heating and/or cooling elements, e.g. three or more or a plurality of heating and/or cooling elements.

The or at least one of the thermal conduction formations may comprise a thermal conduction recess or cavity shaped to cooperate with an outer surface of a massage tool to be heated and/or cooled, e.g. to provide intimate thermal contact therewith. The recess or cavity may comprise an enlarged portion, e.g. for facilitating the removal, in use, of a massage tool located therein.

Additionally or alternatively, the or at least one of the thermal conduction formations may comprise an elongate thermal conduction formation such as a thermal conduction rod or post, which may be shaped to cooperate with a recess or hole in a massage tool to be heated and/or cooled. The or at least one of the elongate thermal conduction formations may be cylindrical and/or may comprise a locating formation which may be at or adjacent one of its ends, e.g. its free end. For example, the elongate thermal conduction formation may comprise a cylindrical rod with a cone shaped end, e.g. free end, and/or a location cradle, e.g. at or adjacent or forming a base thereof.

According to a second aspect of the invention, there is provided a hot stone massage kit comprising one or more massage tools and a heating and/or cooling device as described above.

The kit may comprise two or more heating and/or cooling elements, e.g. three or more or a plurality of heating and/or cooling elements.

The tool may include a recess or hole for cooperation with the elongate thermal conduction formation. The recess or hole may be shorter or longer than the elongate thermal conduction formation and/or may comprise a locating formation therein, e.g. a cone shaped end, which may be configured to cooperate with the locating formation of the elongate thermal conduction formation.

A further aspect of the invention provides a heat transfer apparatus, e.g. a massage tool heat transfer apparatus, the apparatus comprising a thermoelectric device with first and second thermal conduction portions, wherein the thermoelectric device is operable to generate, in use, a temperature difference between the first and second thermal conduction portions in response to an electric voltage applied thereto in order to heat a first massage tool or heat sink or heat dissipation means in thermal contact with the first thermal conduction portion and to cool a massage tool, e.g. a second massage tool, in thermal contact with the second thermal conduction portion.

This arrangement provides a convenient means for simultaneously heating one of the massage tools and cooling another.

Thermoelectric devices, and more specifically devices directed to the application of the Peltier effect, Seebeck effect and/or the Thomson effect, for converting thermal differentials to electric voltage or vice versa, are used in a number of applications. The most common use is in cooling devices, often referred to as Peltier devices. Peltier devices or heat pumps are sometimes used in camping and portable coolers and for cooling electronic components, small instruments and dehumidifiers.

The thermoelectric device is preferably formed of two different materials, e.g. configured to create a heat flux between the junction of the different materials. The materials are preferably selected to provide a predetermined temperature gradient, e.g. when a predetermined electric voltage is applied to the thermoelectric device. Simply connecting it to a DC voltage will cause one side to cool, while the other side warms. The effectiveness of the pump at moving the heat away from the cold side is totally dependent upon the amount of current provided and how well the heat from the hot side can be removed.

The inventor of the present invention has found that such a device is surprisingly effective at transferring heat from one massage tool to another, thereby precluding the need for separate devices as required by prior art arrangements.

It will be appreciated that the first and second thermal conduction portions may be formed integrally. However, any arrangement which is suitable for inducing the required thermoelectric effect to heat, in use, the first massage tool and/or cool the second massage tool is envisaged without departing from the scope of the invention.

The apparatus may further comprise a conductive layer, e.g. on the or at least one of thermal conduction portions, which may facilitate or improve, in use, conduction between the thermal conduction formation and the massage tool or tools. The conductive layer may comprise a flexible, malleable and/or porous material which may also be soaked or filled or retain a quantity of heat conductive fluid such as water. Additionally or alternatively, the conductive layer may be provided by a flexible pouch, e.g. which may be filled with a conductive fluid such as water. Alternatively, the or at least one of the thermal conduction portions or conductive layers may comprise a heat conductive fluid such as water, e.g. which is contained in or retained within a formation.

The conductive layer may be configured to cover, in use, less than 60%, e.g. less than 50% or even less than 40%, of the outer surface of a massage tool.

The apparatus may further comprise one or more thermal conduction formations, e.g. which are in thermal contact with the thermal conduction portions. At least one of the thermal conduction formations may be shaped to approximate a surface of a respective first or second massage tool, for example to provide intimate thermal contact therewith, e.g. whereby heat applied thereto or drawn therefrom, in use, by the thermoelectric device is transferred between the first and second massage tools through the thermal conduction formation and/or heat is prevented from being discharged from or drawn by the first or second massage tool by an insulation formation.

The apparatus may comprise at least one thermal conduction part, e.g. in thermal contact with the first or second thermal conduction portion of the thermoelectric device. The or at least one of the thermal conduction parts may comprise the or a thermal conduction formation, which thermal conduction part or formation may be shaped to approximate a surface of a massage tool, e.g. for providing intimate thermal contact therewith.

The apparatus is preferably configured such that the heat transfer between the first and second massage tools is optimised, for example it may be configured to heat a first predetermined temperature and/or to cool the second massage tool to a second predetermined temperature. It will be appreciated that this may be achieved in a number of different ways depending upon the material and/or thermal mass of the massage tool.

For example, the apparatus may be configured to expose, in use, at least a portion, for example at least 60%, such as at least 50% or 40%, of the first stone. Additionally or alternatively, the apparatus may include an insulation part, e.g. arranged to cooperate, in use, with an outer surface of the first or second massage tool such as by being flexible or deformable to approximate the shape of the outer surface of thereof. The insulation part may include an insulation formation or recess or cavity, which may be shaped to cooperate with an outer surface of the first or second massage tool. Preferably, the insulation formation or recess or cavity is on a surface of the insulation part which faces the or one of the thermal conduction portions or parts or formations in use. In one class of embodiments, the insulation part or formation cooperates, in use, with the or one of the thermal conduction formation to substantially surround the first or second massage tool.

The apparatus may further comprise a heat sink part, e.g. arranged to cooperate, in use, with an outer surface of the first or second massage tool such as by being flexible or deformable to approximate the shape of the outer surface of thereof. The heat sink part may include a heat sink formation or recess or cavity, which may be shaped to cooperate with an outer surface of the first or second massage tool. Preferably, the heat sink formation or recess or cavity is on a surface of the heat sink part which faces the or one of the thermal conduction portions or parts or formations in use. In one class of embodiments, the heat sink part or formation cooperates, in use, with the or one of the thermal conduction formation to substantially surround the first or second massage tool. The heat sink formation may comprise one or more heat dissipation formations, for example one or more fins, e.g. for increasing heat transfer to the ambient surroundings.

The apparatus may comprise a controller for controlling the temperature of the first and/or second massage tool or tools. Additionally or alternatively, the apparatus may comprise a temperature sensor or thermostat for measuring and/or controlling the temperature of one or more elements of the apparatus, e.g. the first and/or second thermal conduction portion or portions and/or the thermal conduction part or parts and/or formation or formations. Additionally or alternatively, the apparatus may comprise a temperature sensor or thermostat for measuring and/or controlling, in use, the temperature of the first and/or second massage tool.

The or each thermal conduction part and/or insulation part may comprise two or more conduction or insulation formations, e.g. three or more or a plurality of conduction or insulation formations.

Additionally or alternatively, the apparatus may include a heater, a cooler or a second thermoelectric device with a third thermal conduction portion. The heater or second thermoelectric device may be operable to heat, in use, the third thermal conduction portion, e.g. to heat the first massage tool, at least a portion of which may be in thermal contact with the third thermal conduction portion. Alternatively, the cooler or second thermoelectric device may be operable to cool, in use, the third thermal conduction portion, e.g. to cool the second massage tool, at least a portion of which may be in thermal contact with the third thermal conduction portion.

In some embodiments, the apparatus may include a second thermoelectric device with third and fourth conduction portions, wherein the thermoelectric device may be operable to heat, in use, the third thermal conduction portion and to cool the fourth thermal conduction portion. The third thermal conduction portion may be arranged to heat the first massage tool, at least a portion of which may be in thermal contact with the third thermal conduction portion. The fourth thermal conduction portion may be arranged to cool the second massage tool, at least a portion of which may be in thermal contact with the fourth thermal conduction portion.

The or at least one of the thermal conduction formations may comprise a thermal conduction recess or cavity shaped to cooperate with an outer surface of the first or second massage tool, e.g. to provide intimate thermal contact therewith. The recess or cavity may comprise an enlarged portion, e.g. for facilitating the removal, in use, of a massage tool located therein.

Additionally or alternatively, the or at least one of the thermal conduction formations may comprise an elongate thermal conduction formation such as a thermal conduction rod or post, which may be shaped to cooperate with a recess or hole in a massage tool to be heated or cooled. The or at least one of the elongate thermal conduction formation may be cylindrical and/or may comprise a locating formation which may be at or adjacent one of its ends, e.g. its free end. For example, the elongate thermal conduction formation may comprise a cylindrical rod with a cone shaped end, e.g. free end, and/or a location cradle, e.g. at or adjacent or forming a base thereof.

The apparatus may further comprise a retaining means or member, which may retain, in use, the first and/or second massage tool in place, e.g. it may be resiliently biased, in use, against the first or second massage tool. Preferably, the retaining means or member comprises an arm which may be resilient and/or which may abut, for example be resiliently urged, in use, against the opposite side of the first or second massage tool, e.g. when the first or second massage tool is in thermal contact with the first or second thermal conduction portion or part or formation. More preferably, the retaining means or member comprises a pair of arms, wherein a first of the arms may retain, in use, the first massage tool in place and/or a second of the arms may retain, in use, the second massage tool in place.

Advantageously, the retaining means or member or one or both of the arms may comprise or incorporate the or a temperature sensor or thermostat. Alternatively, the or a temperature sensor or thermostat may be located in or on the retaining means or member or one or both of the arms.

According to a second aspect of the invention, there is provided a massage kit, e.g. a stone massage kit or a hot and cold stone massage kit, the kit comprising first and second massage tools and a thermal transfer apparatus as described above.

The first and/or second tool may comprise a flattened side or face for cooperation with the first and/or second thermal conduction portions or parts or formations.

Additionally or alternatively, tool may include a recess or hole for cooperation with the elongate thermal conduction formation. The recess or hole may be shorter or longer than the elongate thermal conduction formation and/or may comprise a locating formation therein, e.g. a cone shaped end, which may be configured to cooperate with the locating formation of the elongate thermal conduction formation.

The massage tool or tools preferably comprise a massage or therapeutic stone or stones. The first massage tool may comprise basalt and/or the second massage tool may comprise marble.

Embodiments of the invention will now be described by way of example only with reference to the accompanying drawings in which:

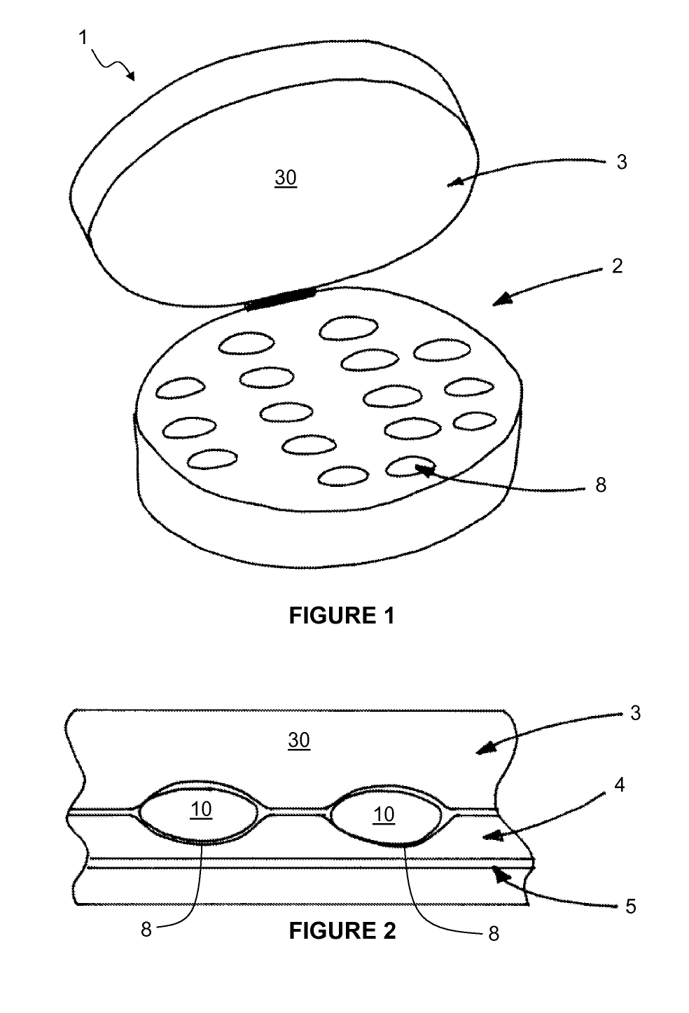

FIG. 1 is a perspective view of a heating device according to a first embodiment of the invention;

FIG. 2 is a partial cross-section of the device of FIG. 1 in use

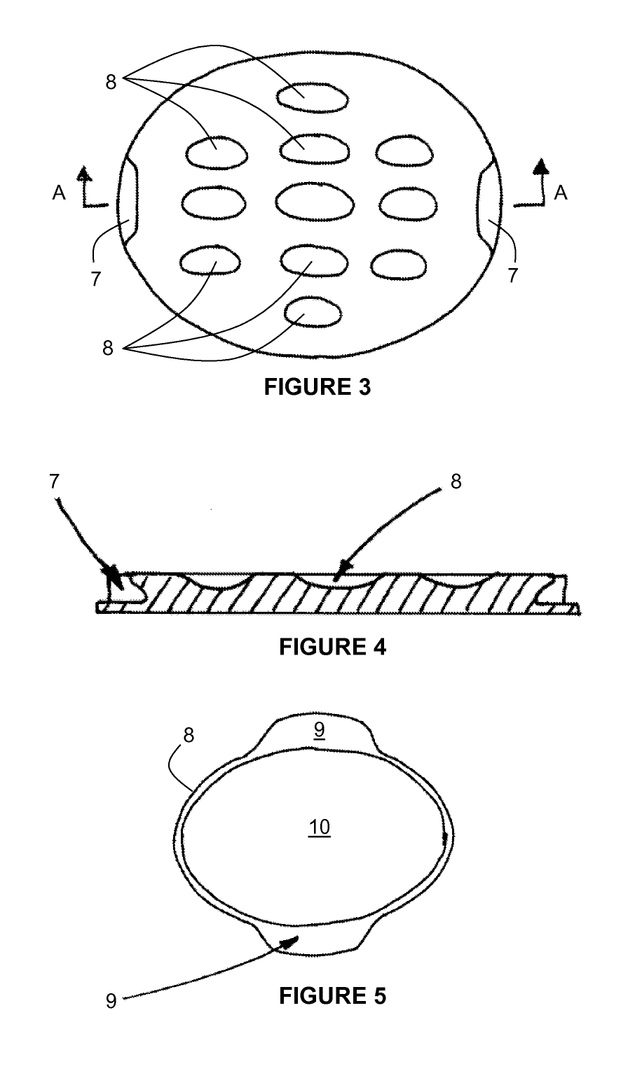

FIG. 3 is a plan view of the lower part of the heating device of FIGS. 1 and 2;

FIG. 4 is a cross-section through line A-A of FIG. 3;

FIG. 5 is a plan view of one of the cavities of the device of FIGS. 1 to 4 with a massage stone received therein;

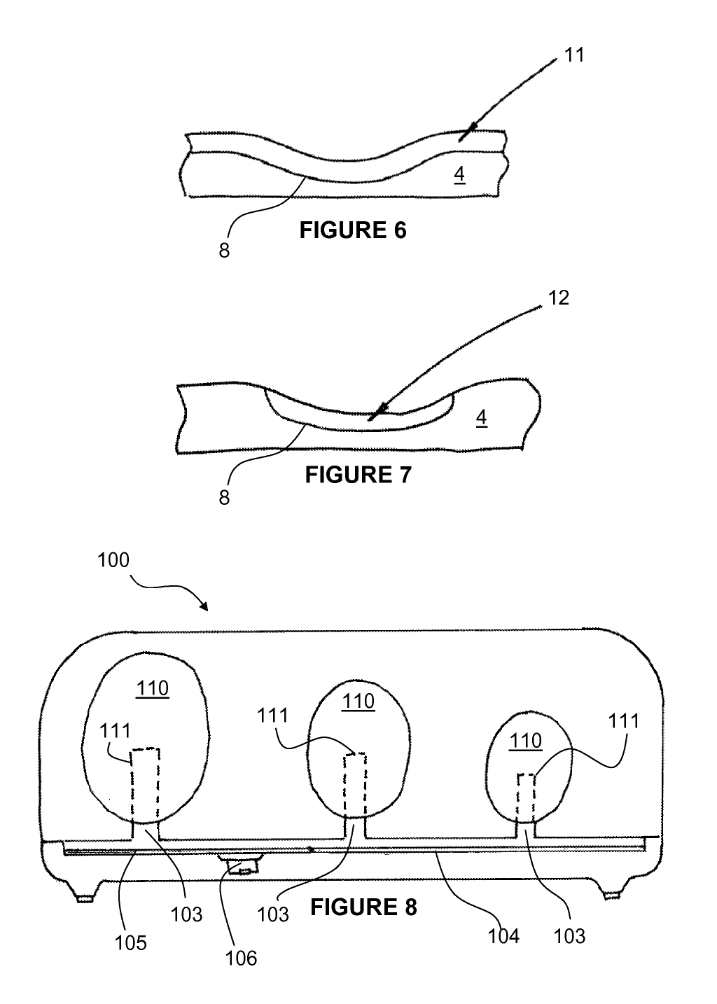

FIG. 6 is a partial section view of one of the cavities of the heating device of FIGS. 1 to 5 showing the conductive layer;

FIG. 7 is a partial section view of an alternative arrangement to that of FIG. 6, wherein each cavity has a discreet conductive layer;

FIG. 8 is a front view of a heating device according to a second embodiment of the invention;

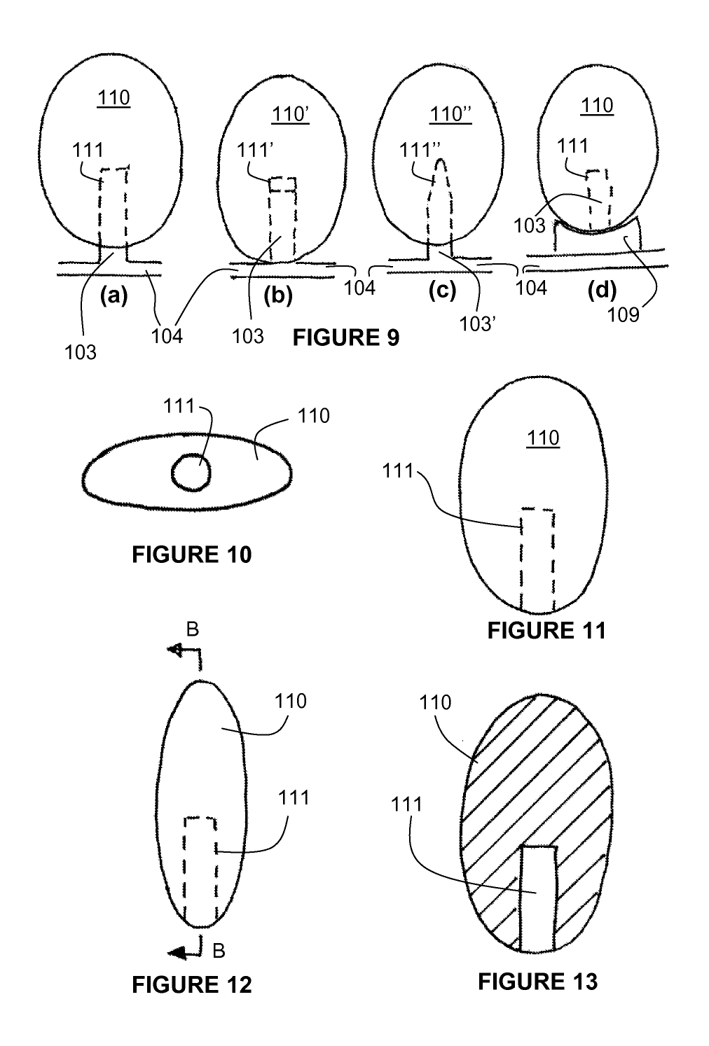

FIG. 9 illustrates four different heating rod designs;

FIG. 10 is a bottom view of a massage stone for use with the heating device of FIG. 8;

FIG. 11 is a front view of the massage stone of FIG. 10;

FIG. 12 is a side view of the massage stone of FIGS. 10 and 11;

FIG. 13 is a section view of the massage stone through line B-B;

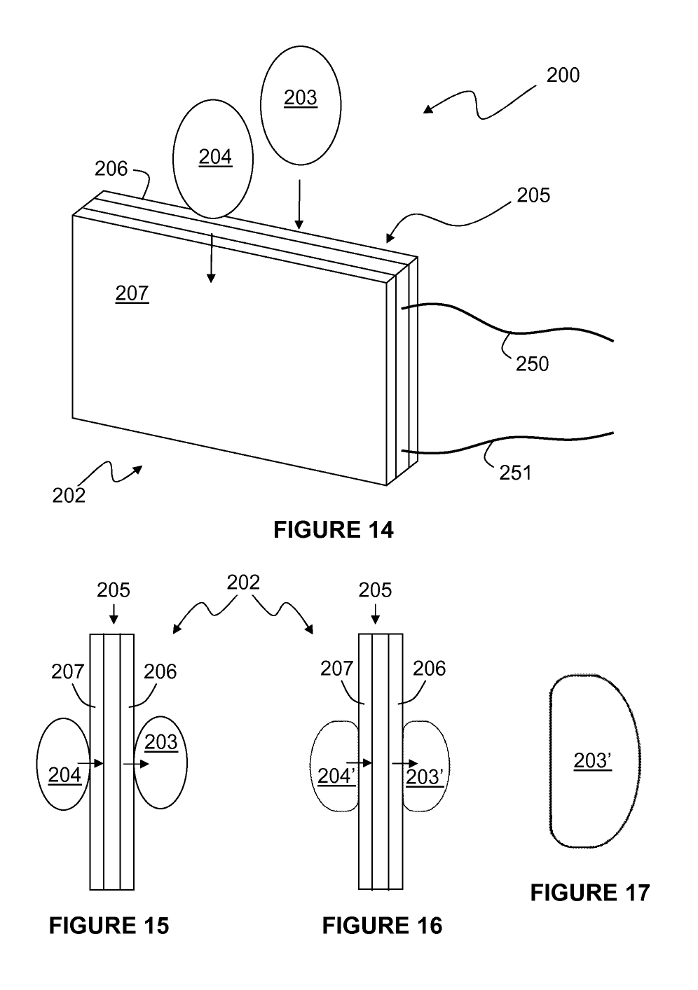

FIG. 14 is a perspective view of a thermal transfer apparatus according to a third embodiment of the invention;

FIG. 15 is a section view of the apparatus of FIG. 14 in use with one embodiment of massage stones showing the path of the heat flux;

FIG. 16 is a similar view to that of FIG. 15 but with a further embodiment of massage stones showing the path of the heat flux;

FIG. 17 is a section view of one of the massage stones of FIG. 16;

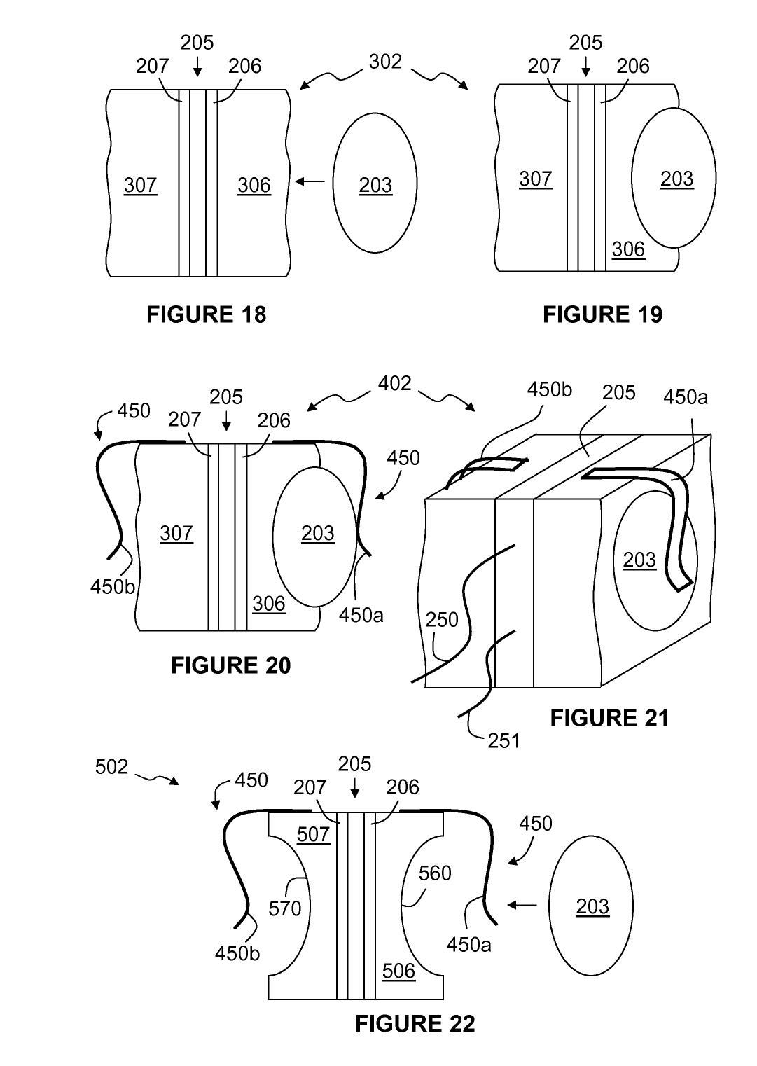

FIG. 18 is a section view of a thermal transfer apparatus according to a fourth embodiment of the invention immediately before use;

FIG. 19 is a similar view to FIG. 18 when the apparatus is in use;

FIG. 20 is a section view of a thermal transfer apparatus according to a fifth embodiment of the invention;

FIG. 21 is a perspective view of the apparatus of FIG. 20;

FIG. 22 is a section view of a thermal transfer apparatus according to a sixth embodiment of the invention;

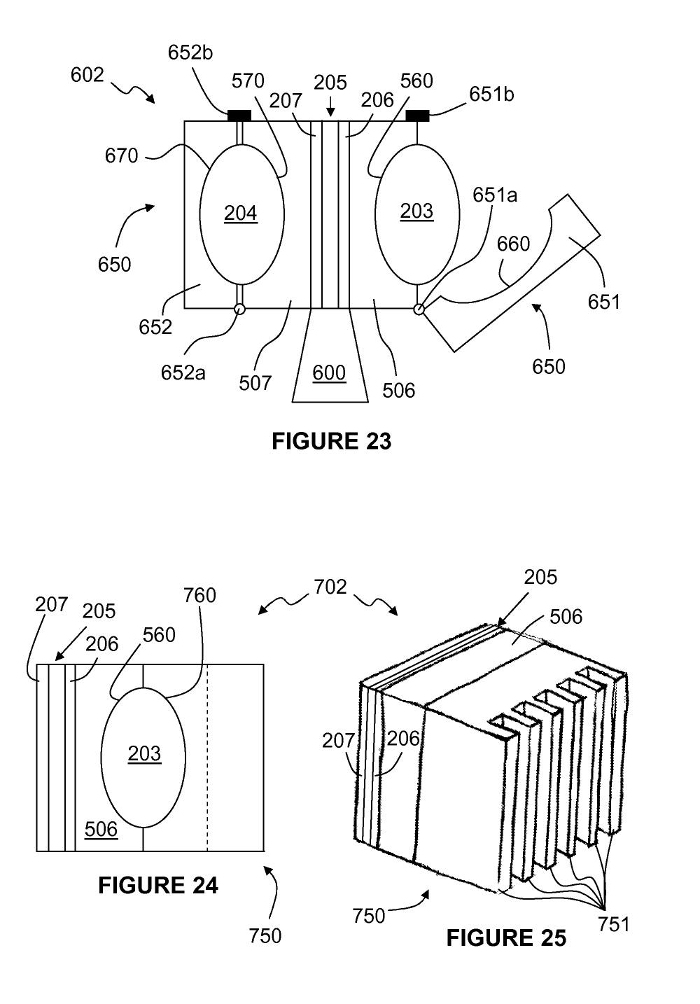

FIG. 23 is a section view of a thermal transfer apparatus according to a seventh embodiment of the invention;

FIG. 24 is a section view of a thermal transfer apparatus according to a eighth embodiment of the invention; and

FIG. 25 is a perspective view of the apparatus of FIG. 24.

Referring now to FIGS. 1 to 5, the heating device 1 has a base assembly 2 and a lid 3. The base assembly 2 includes a conduction plate 4 with a plurality of recesses 8 formed to receive a set of massage tools 10. The recesses 8 may be of different dimensions to match different sized massage tools 10. The edges of the recesses 8 are widened locally 9 in this embodiment to allow easy removal of the massage tools 10 from the conduction plate 4. Of course the widened recesses 8, 9 need not be present for the invention to function, but they offer advantages which would be clear to the skilled person.

The conduction plate 4 is heated by a heating element 5 in the form of a heating layer 5 in this embodiment. The heating element 5 is preferably in contact with the conduction plate 4 such that heat is transferred to the conduction plate 4 primarily by conduction. In some embodiments, however, the heating element 5 may be spaced away from the conduction plate 4 and heat transferred to the conduction plate 4 primarily by radiation.

The conduction plate 4 is made from a material with high thermal conductivity, for example a metal such as Aluminium or a ceramic such as Alumina in order that the heat from the heating element 5 is rapidly transferred to the massage tools 10.

The massage tools 10 are ideally made from a material with a relatively high specific heat capacity to ensure that the massage tool 10 releases its stored heat over an extended period during use. High density, high specific heat capacity and low thermal conductivity natural materials such Basalt, Jade or Granite or composite materials such as Concrete are ideal although metals such as Aluminium may also be used.

A thermostat (not shown) is arranged to be in contact with the conduction plate 4 to control temperature. The thermostat (not shown) is an on/off device in this embodiment. However, in other embodiments the device may include a temperature sensor connected to an electronic control to give more precise and adjustable temperature control.

The conduction plate 4 according to this embodiment is designed to be removable, e.g. for cleaning as the massage tools 10 may transfer massage oil to the conduction plate 4 that may need removal periodically. The removal of the conduction plate 4 with the massage tools 10 in place could also allow a set of hot massage tools 10 to be transferred closer to a treatment area (not shown). Although the conduction plate or tray 4 would have been removed from the heating element 5, the mass of the conduction plate 4 would help to maintain temperature in the massage tools 10 for a longer period of time. In such embodiments, the conduction plate 4 may advantageously include recesses 7 which function as handles 7 to facilitate removal. These handles 7 may take any convenient form and need not necessarily be configured as shown in the appended drawings.

Referring now to FIGS. 6 and 7, the conduction plate 4 may have a conduction layer 11, 12 on the face which carries the recesses 8 to provide the intimate thermal contact with the massage tools 10. The conduction layer 11, 12 is preferably deformable to more closely contact the massage tools 10. In the embodiment of FIG. 6, the conductive layer 11 covers the entire face of the conduction plate 4 that is in contact with the massage tools 10. FIG. 7 shows an alternative embodiment, wherein the conduction layer 12 is restricted to the area of the recesses 8.

The conduction layer 11, 12 may be porous and may be soaked in water or other suitable heat conductive fluid (not shown) to improve conduction of heat to the massage tools 10.

Alternatively, the conduction layer 11, 12 may be provided solely by a fluid between the conduction plate 4 and the massage tools 10. The conduction plate 4 may be formed on its upper side as a shallow tray to receive water (not shown) or other suitable heat conductive fluid (not shown). The thin layer of fluid (not shown) may cover the whole of the upper surface of the conductive plate 4 or may be restricted to the area of the recesses 8.

The lid 3 is thermally insulating in this embodiment, wherein a thermally insulating material 30 is in contact with and surrounds the upper surfaces of the massage tools 10 to reduce heat loss, increase speed of heating and efficiency of the heating device 1. The insulation 30 is resiliently deformable in this embodiment, but in other embodiments it may also or alternatively be preformed to closely surround the massage tools 10.

Alternatively the lid 3 may incorporate a further conduction plate 4 and heating element 5.

Referring now to FIG. 8, there is shown a heating device 100 according to a second embodiment of the invention. This heating device 100 includes a base plate 104 with a three heat conducting rods 103 protruding perpendicularly from the base plate 104. The base plate 104 includes a heating element 105 in the form of a tubular sheathed element in this embodiment. However, in other embodiments the heating element 105 may comprise a wire or ribbon resistor (not shown) wrapped around a mica carrier sheet (not shown).

Therapeutic massage tools 110 having recesses 111 closely matching the dimensions of the heat conducting rods 103 are placed over the rods 103 for heating. The recesses 111 may be formed by machining to allow precise and/or intimate contact between the massage tools 110 and the heated rods 103, regardless of the exterior shape or surface finish of the massage tool 110.

A thermostat 106 is attached to the base plate 104 to control the temperature of the massage tools 110. The thermostat 106 is an on/off device in this embodiment, but it may advantageously comprise a temperature-measuring device (not shown) connected to an electronic control unit (not shown) to give more precise and adjustable temperature control in other embodiments.

The shape of the rods 103 and the recesses 111 in this embodiment are cylindrical and sized to allow the massage tools 110 to rest on the end of the rod 103 when mounted as shown more clearly in FIGS. 9a and 10 to 13.

Alternatively and as shown in FIG. 9b, the massage tool 110′ may be configured with a recess 111′ which is longer than the rod 103, allowing the massage tool 110′ to rest either on the base plate 104 or on a shoulder (not shown) protruding from the rod 103. The end of the rod 103′ may be in the form of a cone with the recess 111″ formed to match the cone end of the rod 103′, as shown in FIG. 9c. This arrangement improves location and heat conduction to the massage tool 110″.

As shown in FIG. 9d, a shaped location component 109 may be provided to support the massage tool 110 and to orientate non-round tools or stones 110 in an array within the device 100. The rods 103, 103′ may have different dimensions in terms of length and/or cross section. Smaller massage tools 110, 110′, 110″ and their corresponding recesses 111, 111′ may be matched with smaller rods 103, 103′ to balance the heat conduction from the base plate 104 to massage tools 110, 110′, 110″ of different sizes to ensure that multiple massage tools 110, 110′, 110″ reach the same operating temperature.

The device 100 may be provided with a lid (not shown). The lid (not shown) may incorporate thermal insulation (not shown). The thermal insulation (not shown) may contact and surround the upper and/or outer surfaces of the massage tools 110, 110′, 110″ to reduce heat loss, increase speed of heating and/or efficiency of the device 100. The insulation (not shown) may deformable and/or be preformed to closely surround the massage tools 110, 110′, 110″. The preformed insulation (not shown) may be used in combination with the shaped location components 109 that orientate non-round massage tools 110, 110′, 110″ to ensure that when the lid (not shown) is brought down, the massage tool or tools 110, 110′, 110″ is or are able to fit into the preformed insulation (not shown).

The massage tools 10, 110 are ideally be made from a material with a relatively high specific heat capacity to ensure that the massage tool 10, 110 releases its stored heat over an extended period during use. High density, high specific heat capacity and low thermal conductivity natural materials such a Basalt, Jade or Granite or composite materials such as Concrete are ideal, although metals such as Aluminium may also be used.

Referring now to FIGS. 14 and 15, there is shown a stone massage kit 200 including a massage tool heat transfer apparatus 202 and first and second massage tools 203, 204. The apparatus 202 includes a thermoelectric device 205, or Peltier heat pump 205, with a pair of electrical wires 250, 251, first and second thermal conduction portions 206, 207 and a thermostat (not shown) in each of the conduction portions 206, 207. The massage tools 203, 204 are therapeutic massage stones 203, 204 in this embodiment, the first stone 203 being formed of basalt and the second stone 204 being formed of marble.

The thermoelectric device 205 is configured to generate a temperature difference between the first and second thermal conduction portions 206, 207 by application of electrical power through the electrical wires 250, 251. When electrical power is applied, the device 205 heats first thermal conduction portion 206 and cools the second thermal conduction portion 207. The first and second thermal conduction portions 206, 207 are formed of a material having a relatively high thermoelectric power, or Seebeck coefficient. More specifically, the material is selected to ensure that the magnitude of the temperature difference generated by the thermoelectric device 205 in response to an induced thermoelectric voltage is sufficient to heat the basalt stone 3 and to cool the marble stone 204.

In use and as shown in FIG. 15, the first stone 203 is placed such that it abuts and is in thermal contact with the first thermal conduction portion 206 and the second stone 204 abuts and is in thermal contact with the second thermal conduction portion 207. Electrical power is then applied to the thermoelectric device 205 via the electrical wires 250, 251, thereby generating a temperature differential between the first and second thermal conduction portions 206, 207. The heat flux moves from the second thermal conduction portion 207 to the first thermal conduction portion 206, thereby heating the first thermal conduction portion 206 and cooling the second thermal conduction portion 207. This in turn heats the first basalt stone 203 and cools the second marble stone 204 until one of the thermostats (not shown) is triggered to automatically turn the thermoelectric device 205 off.

FIGS. 16 and 17 illustrate first and second stones 203′, 204′ having an alternative shape with one flat side and one curved side. By applying the flat side of the stone 203′, 204′ to the relevant thermal conduction portion 206, 207, this increases the surface area of the stone 203′, 204′ that is in contact with the thermal conduction portion 206, 207 thereby increasing the heat flux into the first basalt stone 203′ and out of the second marble stone 204′.

FIGS. 18 and 19 show an apparatus 302 according to a fourth embodiment of the invention which is similar to the apparatus 202 according to the third embodiment, wherein like references represent like features. This apparatus 302 differs from the previous embodiment in that it includes first and second thermal conduction parts 306, 307 which are secured to and in thermal contact with the first and second thermal conduction portions 206, 207 respectively.

The thermal conduction parts 306, 307 are made of a flexible porous material in this embodiment and are soaked with a heat conductive fluid such as water. Thus, when the massage stone 203, 204 is urged thereagainst, the thermal conduction part 306, 307 deforms to approximate the external shape thereof as shown more clearly in FIG. 19.

The apparatus 402 shown in FIGS. 20 and 21 is similar to the apparatus 302 of FIGS. 18 and 19, wherein like references correspond to like features, but for the addition of a retaining means 450 in the form of a pair of spring clips 450a, 450b. The clips 450a, 450b provide a convenient way of retaining the stones 203, 204 in good thermal contact with the thermal conduction parts 306, 307.

The apparatus 502 shown in FIG. 22 is similar to the apparatus 402 of FIGS. 20 and 21, wherein like references correspond to like features. However, the thermal conduction parts 506, 507 in this embodiment are pre-formed with recesses 560, 570 which match substantially the outer contour of the massage stones 203, 204 and are formed from a non-porous rigid or semi-rigid material with good thermal transfer properties. Whilst this arrangement is simpler than the previous design of thermal conduction parts 306, 307, it has reduced flexibility in terms of the massage stone 203, 204 shapes it can accommodate.

The apparatus 602 shown in FIG. 23 is similar to the apparatus 502 of FIG. 22, wherein like references correspond to like features. However, the apparatus 602 includes a stand 600 and the retaining means 650 in this embodiment is in the form of a pair of insulation parts 651, 652 instead of the spring clips 450a, 450b. Each insulation part 651, 652 is hinged to a respective thermal conduction part 506, 507 by a hinge 651a, 652a and is latched thereto by a latch 651b, 652b. The insulation parts 651, 652 are made of a material with good thermal insulation properties with a respective recess 660, 670 pre-formed therein that matches substantially the outer contour of the massage stones 203, 204.

It will be appreciated that the use of insulation parts 651, 652 further improves the effectiveness of the apparatus 602. More specifically, the first insulation part 651 inhibits the loss of heat from the first massage tool 203 to the ambient air and the second insulation part 652 inhibits the tendency of the second massage tool 204 to be heated by the ambient air.

The apparatus 702 shown in FIGS. 24 and 25 is similar to the apparatus 602 of FIG. 23, wherein like references correspond to like features. However, in this apparatus 702 the first insulation part 651 is replaced with a heat sink 750 with a plurality of fins 751 on one side and a recess 760 pre-formed therein on its other side that matches substantially the outer contour of the massage stones 203.

This arrangement may also be arranged to circumvent the need for a thermostat (not shown), since the heat sink 750 automatically regulates the temperature of the first massage stone 203 when the heat flux reaches an equilibrium state. Whilst only one side of the apparatus 702 is shown, it will be appreciated that the second insulation part 652 may also be replaced with a second heat sink (not shown) to provide a similar function for regulation of the temperature of the second massage tool 204.

It will be appreciated by those skilled in the art that several variations to the embodiments described herein are envisaged without departing from the scope of the invention. For example, the conduction plate 4 need not be removable from the device 1. It may be fixed in place, e.g. bonded to provide improved conduction between the heating element 5 and the conduction plate 4. Also, the thermal conduction formations may take any suitable form which is capable of achieving the aforementioned and/or claimed function.

Moreover, the conduction plate 4 need not include recesses 8. For example, it is envisaged that it might be more cost effective to provide a flat conduction plate 4 with a flat conductive layer 11 placed or located thereon. Advantageously, the conductive layer 11 could be configured to deform and/or to conform at least partially to the shape of a stone 10 placed, in use, thereon.

The thermal conduction parts 506, 507 with pre-formed recesses 560, 570 may include an enlarged portion (not shown) to facilitate removal of a massage tool therefrom and/or include a conductive layer (not shown) to facilitate or improve conduction. The conductive layers (not shown) may comprise a flexible, malleable and/or porous material which may also be soaked or filled or retain a quantity of heat conductive fluid such as water. Alternatively, the or at least one of the conductive layers may comprise a heat conductive fluid such as water, e.g. which is retained within the formation or recess or cavity. The massage tools may be formed of any suitable material.

Moreover, the thermostat may be replaced by one or more temperature sensors (not shown) which measures the temperature and feeds the information to a controller (not shown). The controller (not shown) may be arranged to control the thermoelectric device 205 based on the temperature of the first and/or second thermal conduction portion, part or formation and/or the first and/or second massage tool or tools.

Additionally or alternatively, the thermoelectric apparatus or device 202, 302, 402, 502, 602, 702 may include a heater (not shown), a cooler (not shown) or a second thermoelectric device (not shown) which cooperates with the thermal conduction portions 206, 207 or parts 306, 307, 506, 507 to enhance the heating or cooling of the first and/or second massage tools 203, 204. Additionally or alternatively, the or at least one of the thermal conduction parts 306, 307, 506, 507 may incorporate formations (not shown), for example a thermal conduction rod or post (not shown), which may be shaped to cooperate with a recess or hole (not shown) in the first or second massage tool. The formation or formations (not shown) may include a locating formation such as a cone shaped end (not shown).

It is further intended that the apparatus 202 is able to heat and/or cool two or more, preferably a plurality, of massage tools simultaneously. This may be achieved by increasing the size of the thermal conduction portions 206, 207 and/or parts 306, 307, 506, 507 and/or increasing the number of recesses 360, 370, 560, 570.

It will also be appreciated by those skilled in the art that any number of combinations of the aforementioned features and/or those shown in the appended drawings provide clear advantages over the prior art and are therefore within the scope of the invention described herein.

1. A massage tool heating or cooling device for heating or cooling one or more massage tools, the device comprising a heating or cooling element, a flexible conductive pouch and a conduction plate between the heating or cooling element and the conductive pouch, the pouch being deformable to cooperate with a surface of a tool to be heated in order to provide intimate thermal contact therewith, whereby heat applied or removed, in use, by the heating or cooling element is transferred to or from the massage tool through the conduction plate and through the conductive pouch.

2. (canceled)

3. Device according to claim 1, wherein the conductive pouch comprises a porous material soaked, in use, with a quantity of heat conductive fluid.

4. (canceled)

5. Device according to claim 1, wherein the flexible pouch is filled with a conductive fluid.

6. (canceled)

7. Device according to claim 1, wherein the conductive pouch is configured to cover, in use, less than 60% of the outer surface of a massage tool.

8. Device according to claim 1, wherein the conduction plate further comprises a thermal conduction formation shaped to approximate a surface of a tool, wherein the conductive pouch is located on or in the thermal conduction formation.

9. Device according to claim 8, wherein the thermal conduction formation comprises a silicon material loaded with conductive particles.

10. Device according to claim 1, wherein the device is configured to heat or cool the one or more massage tools to a predetermined temperature.

11. Device according to claim 10 further comprising a control unit for controlling, in use, the temperature of the heating or cooling element and/or the thermal conduction formation and/or the massage tool or tools.

12. Device according to claim 1, wherein the heating or cooling element comprises a thermoelectric device with first and second thermal conduction portions, the thermoelectric device being operable to generate, in use, a temperature difference between the first and second thermal conduction portions in response to an electric voltage supplied thereto in order to heat a first massage tool in thermal contact with the first thermal conduction portion and to cool a second massage tool in thermal contact with the second thermal conduction portion.

13. Device according to claim 12, wherein at least one of the conduction portions comprises the conductive pouch, which pouch is deformable to cooperate with a surface of a tool to be heated or cooled to provide intimate thermal contact therewith.

14. Device according to claim 1 further comprising an insulation part arranged to cooperate, in use, with an outer surface of the massage tool or at least one of the massage tools.

15. A stone massage kit comprising one or more massage tools and a device according to claim 1.

16. Device according to claim 1, wherein the conduction plate is removable.

17. Device according to claim 8, wherein the formation comprises a recess,
wherein the conductive pouch is located in the recess.
